(19) United States
(12) Patent Application Publication
(10) Pub. No.: US 2026/0169282 A1
(43) Pub. Date: Jun. 18, 2026

(54) PROTECTION UNIT AND DETECTION ASSEMBLY FOR A MOTOR VEHICLE

(71) Applicant: VALEO SYSTEMES D'ESSUYAGE, La Verriere (FR)

(72) Inventors: Alexandre FILLOUX, La Verriere (FR); Frederic GIRAUD, La Verriere (FR); Frederic BRETAGNOL, La Verriere (FR)

(73) Assignee: VALEO SYSTEMES D'ESSUYAGE, La Verriere (FR)

(21) Appl. No.: 19/119,801

(22) PCT Filed: Oct. 11, 2023
(86) PCT No.: PCT/EP2023/078263

§ 371 Date: Apr. 10, 2025

(30) Foreign Application Priority Data
Oct. 12, 2022 (FR) FR2210485

(51) Int. Cl. G02B 27/00; B60S 1/56; G01S 7/481; G01S 7/497

(52) U.S. Cl. CPC G02B 27/0006; G01S 7/4813; B60S 1/56; G01S 2007/4977

(57) ABSTRACT

The invention relates to a protection unit for protecting an optical surface and to a detection assembly combining an apparatus emitting or capturing radiation through an optical region of interest of the optical surface. The protection unit further includes at least one wave transducer configured to generate an acoustic wave on or in the optical surface in order to clean the optical region of interest. According to the invention, the optical surface has at least one through-hole through which electrical wires for supplying power to the wave transducer extend.

### TECHNICAL FIELD

The technical context of the present invention is that of sensors, and in particular devices for cleaning an optical surface through which surface said sensors carry out their measurements. More particularly, the invention relates to a protecting unit allowing such cleaning to be carried out, to a detecting assembly comprising such a protecting unit and to a motor vehicle.

### BACKGROUND OF THE INVENTION

Generally, the present invention relates to a protecting unit employing a transducer allowing bodies making contact with the optical surface to be cleaned off, by means of ultrasonic waves. By “clean”, what is meant here is that the transducer is configured to remove bodies that were present in contact with the optical surface so that, after the cleaning operation, the optical surface is free from said bodies.

The present invention has applications in numerous fields. By way of non-limiting example, an objective sought by the present invention is to eliminate effects associated with the accumulation of bodies on an optical surface, such as, in particular, raindrops, frost or snow.

In order to remove these bodies from a surface, when they are in the liquid state and present in the form of drops on the optical surface, it is known to rotate said drops in order to be able to remove them from the surface. A known disadvantage of this technique consists in the fact that it is not suitable for surfaces, the area of which is larger than a few square centimeters.

Use of an electrical field to control the hydrophobicity of a surface is also known, as described for example in KR 2018 0086173 A1. This technique, which is known by the acronym EWOD meaning “Electro Wetting On Devices”, consists of applying a potential difference between two electrodes, so as to electrically bias the surface from which it is wished to remove the drops of liquid, and for the purpose of modifying the wetting properties thereof. By controlling the location of the bias, the drop may then be moved. One known disadvantage of this technique is that it may be implemented only with particular materials, and requires particularly precise positioning of the electrodes over the entire area where it is wished to control wetting properties, making its industrialization, its mass production, and its incorporation into products intended for the automobile industry for example, complex or problematic.

Furthermore, use of a windshield wiper on a windshield of a motor vehicle is of course also known. However, this proven technique has the disadvantage of obstructing a field of view accessible to the driver. Furthermore, each time the windshield wiper passes it spreads fatty particulates deposited on the surface of the windshield. In addition, it is necessary to regularly replace the fittings of the windshield wiper, which become worn during their use. Lastly, this technique cannot be used, or can be used only with difficulty, to clean sensors used on motor vehicles, such as, for example, lidars, proximity sensors or cameras.

To clean windshields or sensors used on motor vehicles, such as lidars, proximity sensors or cameras for example, cleaning methods are known which make it possible to remove a liquid accumulating on an optical surface of the sensor by generating ultrasonic waves and propagating them in or over the optical surface. In particular, document WO 2012/095643 A1 is known, which describes a method for removing raindrops by means of ultrasonic vaporization. The amplitude and frequency of vibration are selected such that raindrops falling on the windshield are vaporized as soon as they enter a vibrating area of the surface of the windshield. However, in order to obtain vaporization of a drop of liquid, of a pool or of a film, the power levels with which the vibrating area needs to be vibrated are high, this limiting their practical implementation, in particular in the context of development of autonomous devices. It is moreover well known that vaporization requires energy levels greater than those required to move drops over a medium.

The techniques described above all have drawbacks associated with their integration into more compact surfaces.

### SUMMARY OF THE INVENTION

One object of the present invention is to provide a new protecting unit in order to address, at least for the most part, the foregoing problems and also afford other advantages.

Another aim of the invention is to prevent electrical wires connected to a wave transducer used to clean an optical region of interest of the optical surface from extending across the optical region of interest.

Another aim of the invention is to optimize installation of a transducer on an optical surface.

According to a first aspect of the invention, at least one of the aforementioned objectives is achieved with a unit for protecting an optical surface intended to be associated with an apparatus configured to sense and/or emit radiation through an optical region of interest of the optical surface, the protecting unit comprising:
the optical surface comprising at least one through-hole in the optical surface;
at least one transducer of waves that is mechanically coupled to the optical surface and configured to generate a wave propagating through the optical surface, the at least one transducer of waves being intended to be electrically connected to an electrical device via at least one electrical wire connected to the at least one transducer.

Advantageously, in the protecting unit according to the invention the at least one electrical wire extends through the at least one through-hole in the optical surface.

In the context of the present invention, the protecting unit allows an apparatus intended to be located behind the optical surface to be protected in order to prevent dust, raindrops or any particulates from reaching the apparatus and hindering its correct operation. In the context of the invention, the protecting unit may be implemented with any apparatus of a motor vehicle, and take any form.

In the context of the present invention, the at least one transducer of waves is an electronic chip configured to be able to generate the waves in question. By way of non-limiting example, the at least one transducer of waves (the expressions “transducer of waves” and “wave transducer” are used interchangeably in the present text) is of the type with an electromechanical comb that when biased electrically allows the waves to be generated, such that they propagate in or over the optical surface, in the direction of and/or into the optical region of interest.

The waves generated by the at least one wave transducer advantageously have a fundamental frequency between 0.1 MHz and 1000 MHz, preferably between 15 MHz and 30 MHz, and for example equal to 20 MHz. In addition or alternatively, the waves generated by the at least one wave transducer advantageously have an amplitude between 1 nanometer and 500 nanometers.

In the context of the present invention, the waves generated by the at least one wave transducer are ultrasonic waves. More particularly, the waves thus generated are one of the following types:
an ultrasonic surface wave, i.e. a Rayleigh wave, when the optical surface has a thickness greater than the wavelength of the ultrasonic surface wave. Such a surface wave propagates at the surface of the optical surface. A Rayleigh wave is preferred because a maximal proportion of the energy of the wave is concentrated on the top of the optical surface over which it propagates, and may be transmitted to a body, a raindrop for example, resting on the optical surface. In this case, the surface wave propagates over the optical surface to which the at least one transducer is acoustically coupled, or even preferably to which it is fastened;
an ultrasonic bulk wave, or Lamb wave, when the optical surface has a thickness less than the wavelength of the ultrasonic bulk wave. Such a bulk wave propagates through the optical surface and makes it possible to “vibrate” the entire optical surface thus traversed by the bulk wave, i.e. both optical faces located opposite each other and forming the optical surface.

Thus, the protecting unit according to the invention makes it possible to clean the optical surface efficiently by means of propagation of waves in said optical surface, such that a body, a raindrop for example, making contact with the optical surface is accelerated by the wave generated by each at least one wave transducer.

In the context of the present invention, the optical surface may be of any type, and may perform any function in relation to one or more apparatuses intended to emit or sense radiation passing through said optical surface and placed facing said optical surface. By way of non-limiting example, the optical surface may be a constituent optical lens of the one or more apparatuses, through which lens the radiation passes, or even a protective surface positioned facing the one or more optical lenses of the one or more apparatuses. Generally, the optical surface is formed from a material that permits propagation of ultrasonic waves emitted by the wave transducer, irrespectively of whether they are surface waves or bulk waves. By way of nonlimiting example, and according to one preferred embodiment of the invention, the optical surface is formed from glass in order to promote propagation of such waves. In addition, the optical surface, or at the very least the optical region of interest, is formed from a material that is transparent to the radiation emitted or sensed by the apparatus intended to be associated with the protecting unit according to the first aspect of the invention. In particular, the radiation emitted or sensed by the apparatus propagates in the optical surface, or at the very least in its optical region of interest, by transmission and/or refraction and/or scattering, in such a way that most of the radiation coming from a first side of the optical surface—or at the very least from its optical region of interest—emerges on the other side of the optical surface, i.e. on a second side of the optical surface—or at the very least of its optical region of interest.

In the context of the present invention, the optical region of interest corresponds to a portion of the optical surface located facing the apparatus intended to be associated with the protecting unit and with said optical surface. The optical region of interest corresponds to the portion of the optical surface in which the radiation emitted or sensed by the apparatus passes through the optical surface.

In the context of the present invention, the through-hole passes right through the optical surface, in a direction that is parallel or substantially parallel to a thickness of the optical surface. The through-hole may be any shape. Preferably, the through-hole is circular. A dimension of the through-hole, measured in the plane of the optical surface, is preferably much smaller than the dimensions of the optical surface. By way of nonlimiting example, the through-hole preferably has a diameter less than 5 mm, and preferably less than 3 mm. A shape and/or a dimension of the through-hole is preferably constant between a first face and a second face of the optical surface, the through-hole opening onto said faces.

In the context of the present invention, the apparatus intended to be associated with the optical surface of the protecting unit is configured to capture and/or emit radiation. For this purpose, it comprises a radiation sensor and/or emitter. The radiation is for example electromagnetic radiation, a spectrum of which has wavelengths that may be located in the visible and/or invisible spectrum. By way of non-limiting example, the apparatus is preferably selected from an optical remote-sensing apparatus, such as for example a lidar, a photographic device, a camera, a radar, an infrared sensor and an ultrasound range finder.

Thus, the protecting unit according to the first aspect of the invention makes it possible to facilitate correct operation of the apparatus with which it is intended to be associated, since the optical region of interest of the optical surface through which radiation is sensed or emitted by said apparatus is cleaned by the wave transducer. This advantageous configuration thus makes it possible to reduce interference between bodies that would otherwise have been present on the optical surface, in the optical regions of interest, and the radiation passing through said optical regions of interest.

The protecting unit according to the first aspect of the invention advantageously comprises at least one of the following refinements, the technical features forming these refinements being able to be implemented alone or in combination:
the at least one through-hole is located at a distance less than or equal to 100 mm from a connection face of the at least one transducer located facing said at least one through-hole. Preferably, this distance is less than or equal to 50 mm, and more preferably less than or equal to 15 mm. This advantageous configuration makes it possible to limit a length along which the at least one electrical wire is secured to the optical surface and thus to limit any undesired interference;
the electrical device to which the at least one wave transducer is intended to be electrically connected is for example an electrical power source or a control unit for controlling the at least one transducer. Thus, in the context of the present invention, the at least one electrical wire connecting the at least one wave transducer to the electrical device is an electrical wire for supplying electrical power for biasing the at least one wave transducer and/or an electrical control wire transmitting an electrical signal for controlling operation of the at least one wave transducer. In the context of the invention, the at least one electrical wire may be an electrical cable comprising one or more electrical wires braided together and/or placed inside an insulating sheath. Alternatively, each at least one electrical wire may comprise a conductive element housed in an insulating sheath;
the optical surface is transparent with regard to the radiation emitted and/or sensed by the apparatus intended to collaborate with the protecting unit. This advantageous configuration allows the radiation emitted or sensed by the apparatus intended to collaborate with the protecting unit to pass through the optical surface without being absorbed or reflected, or negligibly with respect to transmission of said radiation through the optical surface. In other words, the radiation emitted or sensed by the apparatus propagates in the optical surface, by transmission and/or refraction and/or scattering, in such a way that most of the radiation coming from a first side of the optical surface emerges on the other side of the optical surface, i.e. on a second side of the optical surface;
the at least one electrical wire is securely fastened to the optical surface. This advantageous configuration makes it possible to prevent the at least one electrical wire from moving during use of the protecting unit according to the first aspect of the invention, or even breaking or becoming damaged during this use. In the context of the present invention, the at least one electrical wire may be securely fastened to the optical surface by any means;
preferably, the at least one electrical wire is adhesively bonded to the optical surface. In the context of the invention, the at least one electrical wire may be adhesively bonded to the optical surface along the entire length of said at least one electrical wire. Alternatively, the at least one electrical wire may be adhesively bonded to the optical surface non-continuously, or even only at its terminations;
at an end of the through-hole that is far from the at least one transducer, the at least one electrical wire protrudes with respect to the optical surface. In other words, a portion of the at least one electrical wire extending beyond the through-hole, relative to the at least one wave transducer to which said at least one electrical wire is connected, extends in a direction that is not coplanar with said optical surface, in proximity to the through-hole. In other words, the at least one electrical wire extends, beyond the at least one through-hole formed in the optical surface, at a non-zero angle with respect to the optical surface at the end of the through-hole that is far from the at least one transducer;
the at least one electrical wire is kept held in the at least one through-hole by a means for joining said at least one electrical wire to said at least one through-hole. This advantageous configuration makes it possible to prevent the at least one electrical wire from moving in the through-hole through which it extends, so as not to introduce vibrations into the protecting unit according to the first aspect of the invention and to reduce friction between the at least one electrical wire and the through-hole;
the joining means used to join the at least one electrical wire to the at least one through-hole is transparent or translucent to the radiation emitted by the apparatus with which the protecting unit is intended to collaborate. This advantageous configuration makes it possible not to interfere negatively with the operation of the apparatus with which the protecting unit according to the first aspect of the invention is intended to collaborate. By way of nonlimiting example, the joining means comprises an adhesive. The adhesive is introduced into the through-hole in order to join the at least one electrical wire to said through-hole;
the joining means hermetically obturates the at least one through-hole. This advantageous configuration makes it possible to prevent bodies or water or any particulates from getting into the through-hole. Particularly advantageously, the through-hole, once the at least one electrical wire has been passed through it, is filled with adhesive in order to plug completely and hermetically-to air and to water and to atmospheric pressure-the through-hole.

According to a second aspect of the invention, provision is made for a detecting assembly comprising:
a protecting unit according to the first aspect of the invention or according to any of its refinements;
at least the apparatus configured to sense and/or emit radiation through the optical region of interest of the optical surface.

In the context of the present invention, the at least one apparatus is located facing the optical surface, at a distance from or against the optical surface, such that the radiation emitted or sensed by said at least one apparatus passes through the optical region of interest of the optical surface. Thus, the optical surface of the protecting unit forms a protective surface for the at least one apparatus.

The detecting assembly according to the second aspect of the invention advantageously comprises at least one of the following refinements, the technical features forming these refinements being able to be considered on their own or in combination:
the at least one apparatus is secured to the optical surface. In this variant of embodiment, the at least one apparatus and the optical surface are rendered immobile with respect to each other. According to a first variant of embodiment, the at least one apparatus is securely and directly fastened to the optical surface, the at least one apparatus comprising a fastening member collaborating with the optical surface. By way of nonlimiting example, the optical surface may be adhesively bonded to a front portion of the at least one apparatus, or the at least one apparatus may be screwed or snap-fastened to the optical surface. According to a second variant of embodiment, the at least one apparatus is securely fastened to a holder to which the optical surface is also securely fastened. In this second variant of embodiment, the optical surface and the at least one apparatus comprise fastening members collaborating with the holder, such as fastening screws or fastening clips for example;
according to a first embodiment, the at least one transducer is located on a first side of the optical surface opposite a second side on which the at least one apparatus is located. In other words, the at least one apparatus and the at least one wave transducer are located on either side of the optical surface, relative to a direction of propagation of the radiation emitted by the at least one apparatus. This advantageous configuration thus makes it possible to place the at least one transducer on the side of the optical surface sprayed by rain drops and/or particulates and that it is therefore necessary to clean. Thus, in this first configuration, the at least one wave transducer is advantageously configured to generate surface waves in the direction of the optical region of interest;
according to a second embodiment, the at least one transducer and the at least one apparatus are located on the same side of the optical surface. In other words, the at least one apparatus and the at least one wave transducer are located on the same side of the optical surface, relative to a direction of propagation of the radiation emitted by the at least one apparatus. This advantageous configuration thus makes it possible to place the at least one transducer on the side of the at least one apparatus, depending on the available space. Thus, in this second configuration, the at least one wave transducer is advantageously configured to direct bulk waves—or Lamb waves—toward the optical region of interest and through the optical surface, so that they reach the face of the optical surface that is sprayed by rain drops and/or particulates and that it is therefore necessary to clean;
according to a first alternative, the at least one through-hole is located in an intermediate position between the at least one transducer and the optical region of interest through which the at least one apparatus emits and/or senses the radiation. In other words, relative to a plane formed by the optical surface, the at least one through-hole is located between the at least one transducer and the through-hole through which the at least one electrical wire extends. This advantageous configuration thus makes it possible to prevent the at least one electrical wire from passing through the optical region of interest;
according to a second alternative, the at least one transducer is located in an intermediate position between the at least one through-hole and the optical region of interest through which the at least one apparatus emits and/or senses the radiation. In this second alternative, the at least one electrical wire connecting the at least one wave transducer to the electrical device extends, from the at least one wave transducer, in a direction away from the optical region of interest, so as to prevent the at least one electrical wire from passing through the optical region of interest. As a result, the at least one electrical wire passes through the at least one through-hole in order to place the electrical wire in proximity to the apparatus, and on a side called the interior side, of the protecting unit according to the first aspect of the invention, which is not subjected to exterior spray.

According to a third aspect of the invention, a motor vehicle is provided comprising a detecting assembly according to the second aspect of the invention or according to any one of its refinements.

Various embodiments of the invention, incorporating in all of their possible combinations the various optional features described here, are provided.

### BRIEF DESCRIPTION OF DRAWINGS

Other features and advantages of the invention will become more clearly apparent on the one hand from the following description, and on the other hand from a plurality of examples of embodiment that are given non-limitingly and by way of indication with reference to the appended schematic drawings, in which:

FIG. 1 illustrates a schematic electrical profile view of a first exemplary embodiment of a detecting assembly according to the second aspect of the invention and comprising a protecting unit according to the first aspect of the invention;

FIG. 2 illustrates a schematic electrical profile view of a second exemplary embodiment of a detecting assembly according to the second aspect of the invention and comprising a protecting unit according to the first aspect of the invention; and

FIG. 3 illustrates a schematic front view of a third examplary embodiment of a detecting assembly according to the second aspect of the invention and comprising a protecting unit according to the first aspect of the invention.

### DETAILED DESCRIPTION OF THE INVENTION

Of course, features, variants and various embodiments of the invention may be combined with one another, in various combinations, provided that they are not mutually incompatible or exclusive. It will be possible, in particular, to imagine variants of the invention that comprise only a selection of the features described below, in isolation from the other features described, if this selection of features is sufficient to confer a technical advantage or to distinguish the invention from the prior art.

In particular, all the variants and all the embodiments described are combinable with one another if there is nothing preventing this combination from a technical perspective.

In the figures, elements that are common to multiple figures retain the same reference.

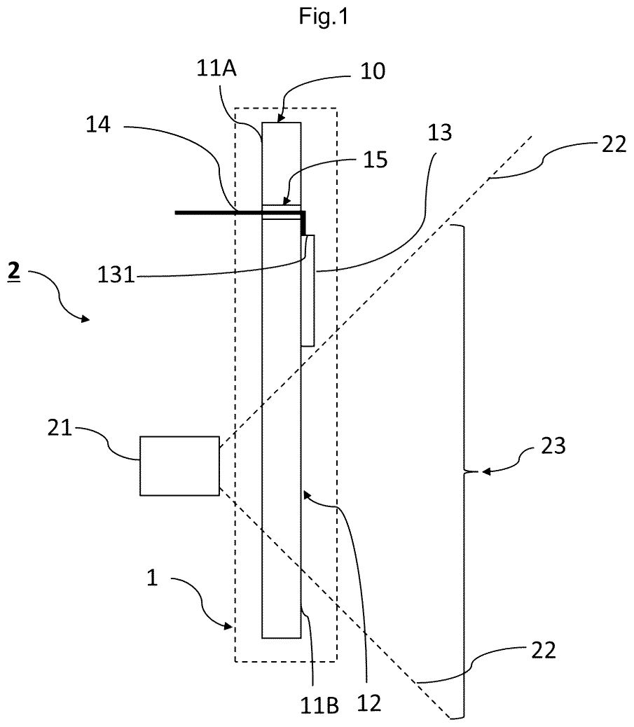

FIG. 1 to FIG. 3 illustrate protection of an optical surface 10 intended to be associated with at least one apparatus 21 configured to sense and/or emit radiation 23 through an optical region of interest 12 of the optical surface 10, the protecting unit 1 comprising:
the optical surface 10 comprising at least one through-hole 15 in the optical surface 10;
at least one transducer 13 of waves W that is mechanically coupled to the optical surface 10 and configured to generate a wave W propagating through the optical surface 10, the at least one transducer 13 of waves W being intended to be electrically connected to an electrical device via at least one electrical wire 14 connected to the at least one transducer 13.

FIG. 1 to FIG. 3 also illustrate a detecting assembly 2 comprising:
a protecting unit 1 such as described above;
at least the apparatus 21 configured to sense and/or emit radiation 23 through the optical region of interest 12 of the optical surface 10.

Each apparatus 21 is located facing the optical surface 10, at a distance from or against the optical surface 10, such that the radiation 23 emitted or sensed by the at least one apparatus 21 passes through the optical region of interest 12 of the optical surface 10.

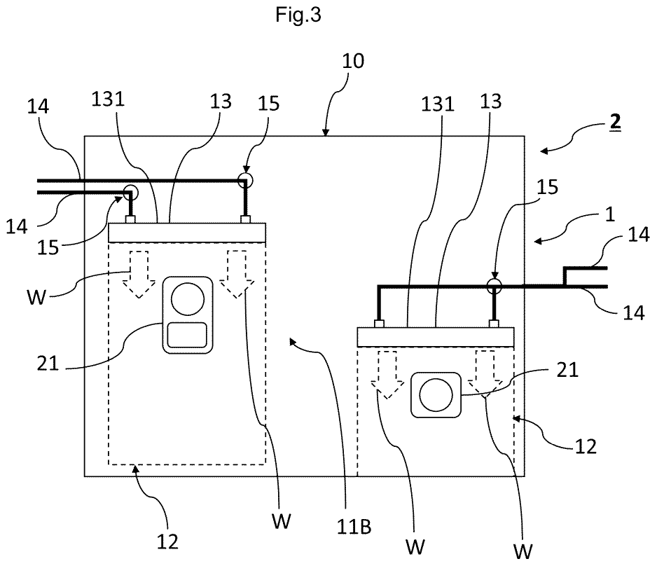

The optical region of interest 12 corresponds to a portion of the optical surface 10 located facing the apparatus 21 intended to be associated with the protecting unit 1 and with said optical surface 10. The optical region of interest 12 corresponds to the portion of the optical surface 10 in which the radiation 23 emitted or sensed by the apparatus 21 passes through the optical surface 10, as shown in FIG. 3.

In the context of the invention, the protecting unit 1 comprises one or more transducers 13 of waves W, each transducer 13 of waves W being electrically connected to the electrical device by way of one or more electrical wires 14. In any case, each electrical wire 14 passes through the optical surface 10 via one or more through-holes 15 produced in the thickness of the optical surface 10.

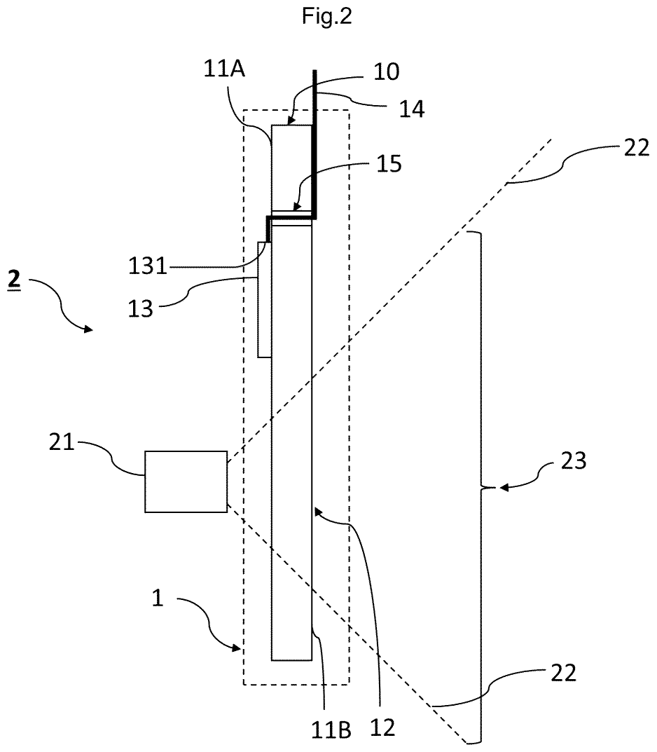

In the context of the invention, each transducer 13 of waves W may be associated with the optical surface 10 in any combination. In particular, as may be seen in FIG. 1, the transducer 13 of waves W may be located, relative to an average direction of propagation of a signal 22 emitted or sensed by the apparatus 21 and forming its radiation 23, opposite the apparatus 21 with respect to the optical surface 10; i.e. on a second face 11B of the optical surface 10. Alternatively, as may be seen in FIG. 2, the transducer 13 of waves W and the apparatus 21 may be located, relative to an average direction of propagation of the signal 22 emitted or sensed by the apparatus 21 and forming its radiation 23, on the same side with respect to the optical surface 10; i.e. on a first face 11A of the optical surface 10.

As may be seen in FIG. 1 and FIG. 2, and in any of the aforementioned configurations, the at least one electrical wire 14 extends through the at least one through-hole 15 in the optical surface 10:
in the example illustrated in FIG. 1, the one or more electrical wires 14 associated with the transducer 13 located on the side of the second face 11B of the optical surface 10 extend first against and over said second face 11B, then extend through the through-hole 15. On the first face 11A of the optical surface 10, the one or more electrical wires 14 protrude from the through-hole 15, in the direction of the apparatus 21 associated with the protecting unit 1;
in the example illustrated in FIG. 2, the one or more electrical wires 14 associated with the transducer 13 located on the side of the first face 11A of the optical surface 10 extend first against and over said first face 11A, then extend through the through-hole 15. On the second face 11B of the optical surface 10, the one or more electrical wires 14 emerge from the through-hole 15 and extend over and against the second face 11B, in a direction away from the optical region of interest 12 of the apparatus 21 associated with the protecting unit 1.

The one or more electrical wires 14 of a transducer 13 of waves W pass through the optical surface 10 via a single through-hole 15 or via a plurality of through-holes 15, depending on geometric and spatial constraints.

Advantageously, as may be seen in FIG. 1 to FIG. 3, the one or more through-holes 15 are located beyond the transducer 13 with which the electrical wires 14 are associated, relative to an optical region of interest 12 of the optical surface 10.

Each through-hole 15 is located at a distance less than or equal to 100 mm from a connection face 131 of the transducer 13 of waves W with which it is associated. The connection face 131 of the transducer 13 of waves W is the face located facing the corresponding through-hole 15. Preferably, this distance is less than or equal to 50 mm, and more preferably less than or equal to 15 mm in order to limit a length along which the at least one electrical wire 14 is secured to the optical surface 10 and thus to limit any undesired interference.

Each electrical wire 14 is preferably securely fastened to the optical surface 10 in order to prevent it from moving or breaking during use of the protecting unit 1. The electrical wires 14 may be securely fastened to the optical surface 10 by any means, and in particular by adhesive bonding.

The through-hole 15 passes right through the optical surface 10, in a direction that is parallel or substantially parallel to a thickness of the optical surface 10, as may be seen in FIG. 1 and FIG. 2 i.e. between a first face 11A and a second face 11B of the optical surface 10, onto which faces 11A, 11B the through-hole 15 opens. The through-hole 15 may be any shape, and in particular circular, as shown in FIG. 3. A dimension of the through-hole 15, measured in the plane of the optical surface 10, is preferably much smaller than the dimensions of the optical surface 10. Furthermore, a diameter of the through-hole 15 is larger than the diameter of the electrical wires 14 connecting the apparatus 21 collaborating with the optical surface 10.

In order to prevent the one or more electrical wires 14 from moving in the through-hole 15 through which they extend and/or in order to reduce friction between the electrical wires 14 and the through-hole 15, the one or more electrical wires 14 are held clamped in the corresponding through-hole 15, by any joining means.

The joining means is advantageously transparent or translucent with respect to the radiation 23 emitted by the apparatus 21 associated with the protecting unit 1, analogously or similarly to the optical surface 10. By way of example, the joining means is an adhesive, hermetically filling each through-hole 15 in which the one or more electrical wires 14 extend.

In the detecting assembly 2 according to the invention, the one or more apparatuses 21 are associated with the protecting unit 1—and more particularly with the optical surface 10 by any means. In particular, the apparatus 21 may be securely and directly fastened to the optical surface 10, by means of fastening tabs or by direct abutment. Alternatively, the apparatus 21 and the optical surface 10 may be secured to each other by way of a common holder to which they are each securely fastened.

As shown in FIG. 3, the detecting assembly 2 comprises a first apparatus 21 and a second apparatus 21, which are placed behind the optical surface 10. Each apparatus 21 emits or senses radiation 23 that defines, on the optical surface 10, an optical region of interest 12. For each of the optical regions of interest 12, a transducer 13 of waves W is associated with the optical surface 10 in order to generate an acoustic wave W that propagates in the direction of the optical region of interest 12 and that will allow it to be cleaned.

For the transducer 13 associated with the apparatus 21 on the left in FIG. 3, each electrical wire 14 allowing the transducer 13 of waves W to be driven extends away from the corresponding optical region of interest 12. Furthermore, each electrical wire 14 passes through one through-hole 15 in the optical surface 10 in order to then run therefrom toward a lateral edge of the optical surface 10.

For the transducer 13 associated with the apparatus 21 on the right in FIG. 3, each electrical wire 14 allowing the transducer 13 of waves W to be driven extends away from the corresponding optical region of interest 12. Furthermore, both the electrical wires 14 pass through the same through-hole 15 in the optical surface 10 in order to then run therefrom toward a lateral edge of the optical surface 10.

In summary, the invention relates to a unit 1 for protecting an optical surface 10 and to a detecting assembly 2 associating an apparatus 21 emitting or sensing radiation 23 through an optical region of interest 12 of the optical surface 10. The protecting unit 1 further comprises at least one transducer 13 of waves W configured to generate an acoustic wave W on or in the optical surface 10 in order to clean the optical region of interest 12. According to the invention, the optical surface 10 comprises at least one through-hole 15 through which electrical wires 14 used to supply electrical power to the transducer 13 of waves W extend.

Of course, the invention is not limited to the examples which have just been described, and many modifications may be made to these examples without departing from the scope of the invention. In particular, the various features, forms, variants and embodiments of the invention may be combined with one another, in various combinations, as long as they are not mutually incompatible or exclusive. In particular, all the variants and embodiments described above are combinable with one another.

1. A unit for protecting an optical surface intended to be associated with an apparatus configured to sense and/or emit radiation through an optical region of interest of the optical surface, the protecting unit comprising:
the optical surface including at least one through-hole in the optical surface;
at least one transducer of waves that is mechanically coupled to the optical surface and configured to generate a wave propagating through the optical surface, the at least one transducer of waves being intended to be electrically connected to an electrical device via at least one electrical wire connected to the at least one transducer;
wherein the at least one electrical wire extends through the at least one through-hole hole in the optical surface.

2. The protecting unit as claimed in claim 1, wherein the at least one electrical wire is securely fastened to the optical surface.

3. The protecting unit as claimed in claim 2, wherein the at least one electrical wire is adhesively bonded to the optical surface.

4. The protecting unit as claimed claim 1, wherein, at an end of the through-hole that is far from the at least one transducer, the at least one electrical wire protrudes with respect to the optical surface.

5. The protecting unit as claimed in claim 1, wherein the at least one electrical wire is kept held in the at least one through-hole by a means for joining the at least one electrical wire to the at least one through-hole.

6. The protecting unit as claimed in the claim 5, wherein the joining means used to join the at least one electrical wire to the at least one through-hole is transparent or translucent to the radiation emitted by the apparatus with which the protecting unit is intended to collaborate.

7. A detecting assembly comprising:
a protecting unit, the protecting unit incudes an optical surface including at least one through-hole in the optical surface, at least one transducer of waves that is mechanically coupled to the optical surface and configured to generate a wave propagating through the optical surface, the at least one transducer of waves being intended to be electrically connected to an electrical device via at least one electrical wire connected to the at least one transducer, and the at least one electrical wire extends through the at least one through-hole in the optical surface; and
at least one apparatus configured to sense and/or emit radiation through the optical region of interest of the optical surface.

8. The detecting assemble as claimed in claim 7, wherein the at least one transducer is located on a first side of the optical surface opposite a second side on which the at least one apparatus is located.

9. The detecting assembly as claimed in claim 8, wherein the at least one trough-hole is located in an intermediate position between the at least one transducer and the optical region of interest through which the at least one apparatus emits and/or senses the radiation.

10. A motor vehicle comprising a detecting assembly, the detecting assembly includes a protecting unit, the protecting unit includes an optical surface including at least one through-hole in the optical surface, at least one transducer of waves that is mechanically coupled to the optical surface and configured to generate a wave propagating through the optical surface, the at least one transducer of waves being intended to be electrically connected to an electrical device via at least one electrical wire connected to the at least one transducer, and the at least one electrical wire extends through the at least one through-hole in the optical surface, and at least one apparatus configured to sense and/or emit radiation through the optical region of interest of the optical surface.
